(19) United States
(12) Patent Application Publication
(10) Pub. No.: US 2022/0037726 A1
(43) Pub. Date: Feb. 3, 2022

(54) BATTERY PACK

(71) Applicant: SK Innovation Co., Ltd., Seoul (KR)

(72) Inventors: Young Sun CHOI, Daejeon (KR); Hae Ryong JEON, Daejeon (KR); Yang Kyu CHOI, Daejeon (KR); Eun Jeong CHOI, Daejeon (KR)

(21) Appl. No.: 17/387,326

(22) Filed: Jul. 28, 2021

(30) Foreign Application Priority Data
Jul. 28, 2020 (KR) 10-2020-0093577

(51) Int. Cl. H01M 50/211; H01M 50/209; H01M 50/291; H01M 10/6551; H01M 10/613

(52) U.S. Cl. CPC H01M 50/211; H01M 50/209; H01M 10/613; H01M 10/6551; H01M 50/291

(57) ABSTRACT

A battery pack includes a plurality of cell stack units, each stack unit including a stack of a plurality of battery cells, a partition wall member disposed between the cell stack units adjacent to each other, and a pack housing accommodating the plurality of cell stack units and a plurality of partition wall members. The cell stack unit and the partition wall member are accommodated in the pack housing while side surface of the cell stack unit and a side surface of the partition wall member are in contact with each other, and the partition wall member is fixed to a bottom surface of the pack housing.

### CROSS-REFERENCE TO RELATED APPLICATION(S)

This application claims the benefit under 35 USC 119 (a) of Korean Patent Application No. 10-2020-0093577 filed on Jul. 28, 2020 in the Korean Intellectual Property Office, the entire disclosure of which is incorporated herein by reference for all purposes.

### BACKGROUND

### 1. Field

The present disclosure relates to a battery pack in which a plurality of battery cells are mounted, and more particularly, to a battery pack for increasing energy density by increasing the number of battery cells accommodated in a predetermined space.

### 2. Description of the Background

Unlike primary batteries, secondary batteries can be charged and discharged. Due to such convenience, secondary batteries have attracted widespread attention as a power supply of various mobile devices as well as a power source for electric vehicles, or the like. For example, a type of secondary battery using a non-aqueous electrolyte having high energy density has higher energy, so that a plurality of such secondary batteries may be connected in series to be used to drive a motor of an electric vehicle.

A battery module, applied to an electric vehicle, is modularized by electrically connecting a plurality of battery cells due to requirement for high energy and high capacity, and the electric vehicle includes a battery pack in which a plurality of such battery modules are arranged to obtain high power.

FIGS. 1 and 2 illustrate an example of a battery pack according to the related art. FIG. 1 is a perspective view illustrating an inside of the battery pack according to the related art, and FIG. 2 is a cross-sectional view taken along line I-I′ of FIG. 1.

Referring to FIGS. 1 and 2, the battery pack 10 according to the related art includes a plurality of battery modules 20 and an electric component 18, such as a battery management system (BMS), mounted in an accommodation space 14 formed inside a pack housing 11.

The battery module 20 has a structure in which a plurality of battery cells 22 are provided inside the module housing 21, and the plurality of battery cells 22 are electrically connected through a bus bar assembly (not illustrated), or the like, to constitute a module structure. In addition, a heat transfer member 23 formed of thermal grease, thermal adhesive, thermally conductive epoxy, a heat dissipation pad, or the like, may be disposed between a lower surface of the battery cell 22 and a bottom surface of the module housing 21 to facilitate dissipation of heat generated in the battery cell 22.

A cooling member 30 may be installed below the pack housing 11 to form a cooling flow path 31 through which a cooling fluid flows so as to discharge heat, generated inside the battery module 20, for example, in the battery cell 11, to an outside of the battery cell 22. In this case, a heat transfer member 18 formed of a thermal adhesive, or the like, may be disposed between a lower surface of the module housing 21 and a bottom surface 12 of the pack housing 11 to fix the module housing 21 to a bottom portion 12 and, simultaneously, to facilitate heat transfer between the module housing 21 and the pack housing 11.

The battery pack 10 according to the related art has a partition wall structure to secure structural rigidity of the pack housing 11. For example, as illustrated in FIG. 1, the pack housing 11 includes a cross member 17, protruding from the bottom portion 12 of the pack housing across the entire pack housing 11 to connect opposing sidewall portions 13 of the pack housing 11, and a partition wall 16 protruding from the bottom portion 12 of the pack housing 11 in the form of connecting the cross member 17 and the sidewall portion 13 to each other. As described above, in the battery pack 10 according to the related art, the cross member 17 and the partition wall 16 form a grid pattern to secure the structural rigidity of the pack housing 11.

In this case, the battery module 20 should secure a separation space, which is 5 mm or more larger than the actual battery module 20, in consideration of an assembly tolerance of the battery module 20, a space for absorbing swelling occurring on the battery cell 22 inside the battery module 20, and the like. For example, as illustrated in FIG. 2, a gap G may be formed between the partition wall 16 and an external surface of the module housing 21.

As described above, due to the gap G between the partition wall 16 and the external surface of the module housing 21, the battery pack 10 according to the related art has a dead space, not used to mount the battery cell 22. An area of such dead space may significantly increase as the number of the battery modules 20 increases.

Accordingly, an increase in area of the dead space may prevent energy density of the battery pack 10 according to the related art from sufficiently increasing.

In addition, the battery pack 10 according to the related art includes the module housing 21, having sufficient thickness and rigidity, installed to support the battery cell 20 between the battery cell 20 and the cooling member 30. Therefore, a heat transfer path between a lower surface of the battery cell 20 and the cooling member 30 may be complicated, so that heat dissipation performance and cooling performance may be deteriorated.

In addition, the battery pack 10 according to the related art has a structure in which four corner portions of the battery module 20 are disposed to correspond to fastening projections 15 protruding from the bottom portion 12, and are fixed by fastening members such as bolts, or the like. In this case, the battery module 20 and the pack housing 11 are coupled only by a fastening structure of the four corner portions and bonding between the lower surface of the battery module 20 and the bottom portion 12 of the pack housing. Therefore, it may be difficult to sufficiently support the battery module 20 having a heavy weight.

### SUMMARY

An aspect of the present disclosure is to provide a battery pack, for increasing energy density by installing more battery cells in the same accommodation space.

Another aspect of the present disclosure is to provide a battery pack, for improving heat dissipation performance of a battery cell and improving cooling performance of the battery pack.

Another aspect of the present disclosure is to provide a battery pack, for sufficiently absorbing swelling of a battery cell.

Another aspect of the present disclosure is to provide a battery pack, for sufficiently securing supporting force of a plurality of battery cells.

Another aspect of the present disclosure is to provide a battery pack, for sufficiently securing structural rigidity of the battery pack.

Another aspect of the present disclosure is to provide a battery pack having improved assemblability.

According to an aspect of the present disclosure, a battery pack includes a plurality of cell stack units, each cell stack including a stack of a plurality of battery cells, a partition wall member disposed between the cell stack units adjacent to each other, and a pack housing, accommodating the plurality of cell stack units and a plurality of partition wall members. The cell stack unit and the partition wall member are accommodated in the pack housing while a side surface of the cell stack unit and a side surface of the partition wall member are in contact with each other, and the partition wall member is fixed to a bottom surface of the pack housing.

The pack housing may include a projection having a structure protruding upwardly of the bottom surface, and the partition wall member may include a coupling portion coupled to the projection for fixing the partition wall member on the bottom surface of the pack housing.

The projection may have a shape linearly protruding in a length direction of the partition wall member, or may have a shape partially protruding in the length direction of the partition wall member.

The projection may have a height equal to half a height of the partition wall member or less.

The partition wall member may be directly and fixedly installed on a bottom surface of the pack housing.

At least a portion of the partition wall member may include a hollow portion having a hollow structure to absorb swelling of any one of the plurality of the battery cells. In this case, the hollow portion may have a shape extending in a vertical direction. The partition wall member may include an external wall defining the hollow portion and a partition wall crossing the hollow portion, and the partition wall may have a thickness smaller than a thickness of the external wall of the partition wall member.

The cell stack unit may include at least one buffer pad disposed between the battery cells.

The plurality of cell stack units and a plurality of partition wall members may constitute a unit assembly, and the unit assembly may be assembled to be integrated with the pack housing.

The pack housing may include a bottom portion having the bottom surface, an external sidewall extending upwardly of a circumference of the bottom portion, and a cooling member installed below the bottom portion.

In this case, the battery pack according to an aspect of the present disclosure further comprises a heat transfer member positioned between a lower surface of the battery cell and the bottom surface of the bottom portion of the pack housing, and heat generated by the battery cell may be transferred to the cooling member through the heat transfer member and the bottom portion.

The cell stack unit may include a casing wrapping at least a portion of the plurality of battery cells in a state in which the plurality of battery cells are stacked. The casing may have a thickness of 0.5 mm or less, and may be formed of a thermally conductive plastic material. The casing may have a shape covering at least a portion of bottom surfaces of the plurality of battery cells establishing a stacked state.

The cell stack unit may include a bus bar assembly to which an electrode tap of the battery cell is connected.

The battery cell may include a pouch-type secondary battery having an accommodation portion, accommodating an electrode assembly therein, and a sealing portion sealing the accommodation portion. Alternatively, the battery cell may include a can-type secondary battery.

The pack housing may include a cross member connecting opposing external sidewalls of the pack housing to each other, and the partition wall member may be installed such that both ends of the partition wall member are in contact with at least one of the external sidewall and the cross member.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a perspective view illustrating an inside of a battery pack according to the related art.

FIG. 2 is a cross-sectional view taken along line I-I′ of FIG. 1.

FIG. 3 is a perspective view illustrating an inside of a battery pack according to an example embodiment of the present disclosure.

FIG. 4 is a perspective view illustrating an example of a battery cell installed in the battery pack illustrated in FIG. 3.

FIG. 5 is a cross-sectional view taken along line II-II′ of FIG. 3.

FIG. 6 is a cross-sectional view taken along line III-III′ of FIG. 3.

FIG. 7 is a schematic perspective view illustrating the state in which a cell stack unit and a partition wall member, illustrated in FIG. 3, are installed in a pack housing.

FIG. 8 is a schematic perspective view illustrating the state in which a cell stack unit and a partition wall member are installed in a pack housing having a deformed projection.

FIG. 9 is a cross-sectional view illustrating a modified example of the battery pack illustrated in FIG. 5.

FIG. 10 is a cross-sectional view illustrating another modified example of the battery pack illustrated in FIG. 5.

FIG. 11 is a cross-sectional view illustrating another modified example of the battery pack illustrated in FIG. 5.

FIGS. 12A to 12D are perspective views illustrating various modified examples of a casing included in the battery pack illustrated in FIG. 11. FIG. 12A is a perspective view of a casing wrapping all six sides of a cell stack unit, FIG. 12B is a perspective view of a casing wrapping four sides (upper, lower, left, and right sides) of a cell stack unit, FIG. 12C is a perspective view of a casing wrapping portions of wrapping four sides (upper, lower, left, and right sides) of a cell stack unit, and FIG. 12D is a perspective view illustrating a casing wrapping three sides (left, right, and lower sides) of a cell stack unit.

FIG. 13 is a cross-sectional view illustrating another modified example of the battery pack illustrated in FIG. 5.

FIG. 14 is a plan view of the battery pack according to the related art illustrated in FIG. 1.

FIG. 15 is a plan view of the battery pack according to an example embodiment of the present disclosure illustrated in FIG. 3.

### DETAILED DESCRIPTION

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the appropriate method he or she knows for carrying out the present disclosure. Therefore, the configurations described in the embodiments and drawings of the present disclosure are merely appropriate embodiments but do not represent all of the technical spirit of the present disclosure. Thus, the present disclosure should be construed as including all the changes, equivalents, and substitutions included in the spirit and scope of the present disclosure at the time of filing this application.

Hereinafter, embodiments of the present disclosure will be described in detail with reference to the accompanying drawings. In this case, it is to be noted that like reference numerals denote like elements in appreciating the drawings. Moreover, detailed descriptions related to well-known functions or configurations will be ruled out in order not to unnecessarily obscure the subject matter of the present disclosure. Based on the same reason, it is to be noted that some components shown in the drawings are exaggerated, omitted or schematically illustrated, and the size of each component does not exactly reflect its actual size.

Hereinafter, example embodiments of the present disclosure will now be described in detail with reference to the accompanying drawings.

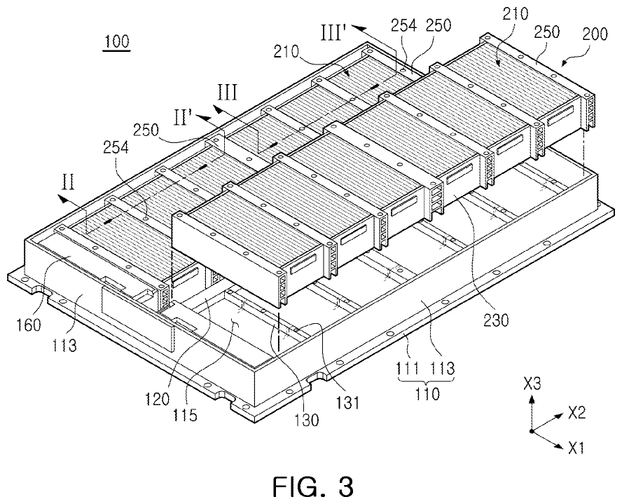

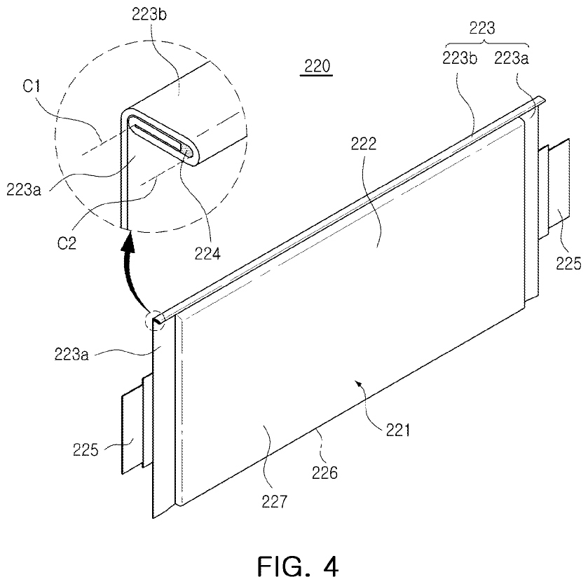

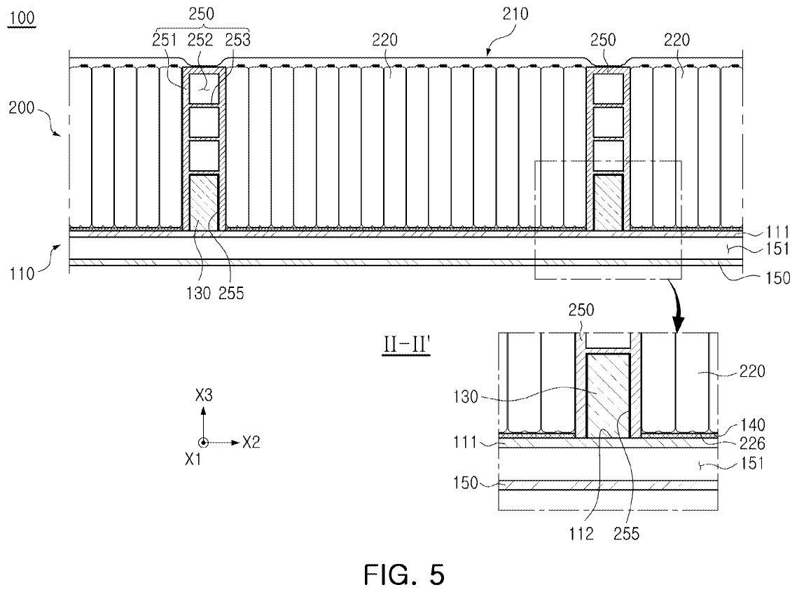

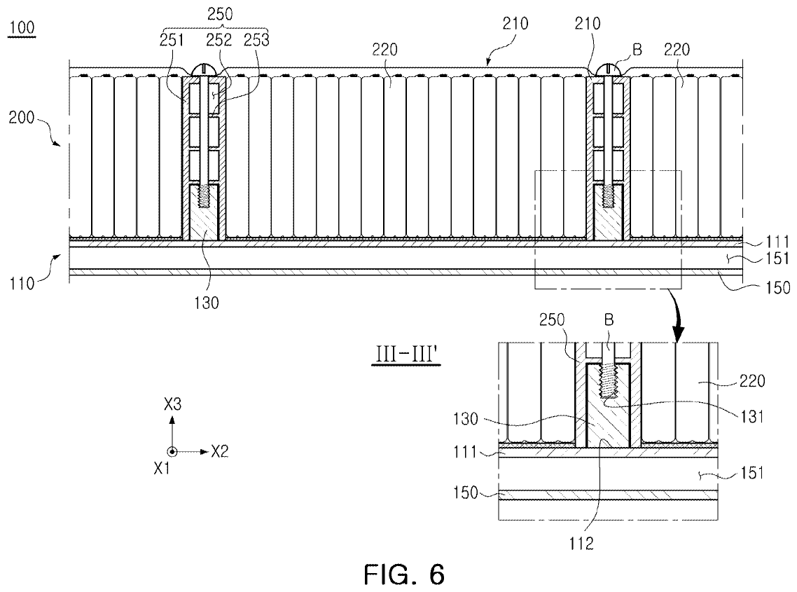

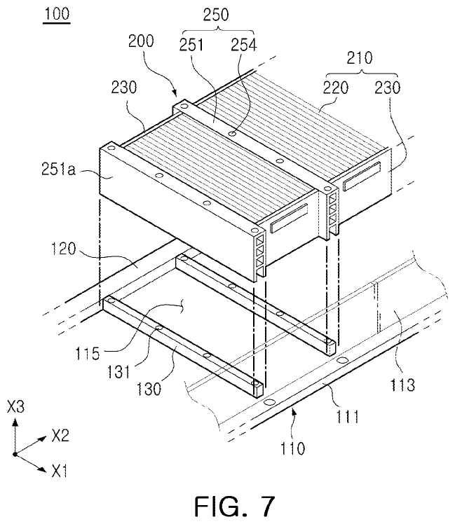

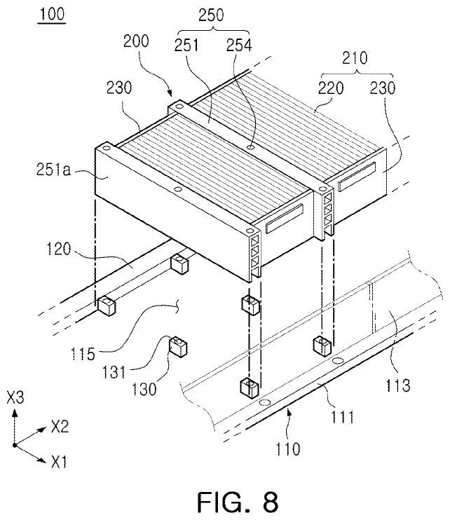

FIG. 3 is a perspective view illustrating an inside of a battery pack 100 according to an example embodiment of the present disclosure, FIG. 4 is a perspective view illustrating an example of a battery cell 220 installed in the battery pack 100 illustrated in FIG. 3, FIG. 5 is a cross-sectional view taken along line II-II′ of FIG. 3, FIG. 6 is a cross-sectional view taken along line of FIG. 3, FIG. 7 is a schematic perspective view illustrating the state in which a cell stack unit 210 and a partition wall member 250, illustrated in FIG. 3, are installed in a pack housing 110, FIG. 8 is a schematic perspective view illustrating the state in which the cell stack unit 210 and the partition wall member 250 are installed in the pack housing 110 having a deformed projection 130.

Referring FIG. 3 and FIGS. 5 to 8, the battery pack 100 according to an example embodiment may be configured to include a cell stack unit 210, a partition wall member 250, and a pack housing 110.

The cell stack unit 210 may be formed by stacking a plurality of battery cells 220. As illustrated in FIG. 3, a plurality of cell stack units 210 may be disposed in the pack housing 110.

The cell stack unit 210 may include a plurality of stacked battery cells 220 illustrated as an example in FIG. 4. In this case, the battery cells 220 may be stacked such that side surfaces 227 are in contact with each other, and side surfaces 227 of adjacent battery cells 220 may be fixed by a double-sided tape. In the present embodiment, the cell stack unit 210 may include a plurality of battery cells 220 stacked in a horizontal direction X2, as illustrated in FIG. 3. However, as necessary, the cell stack unit 210 may include a plurality of the battery cells 220 stacked in a vertical direction X3.

As an example, the battery cell 220 provided in the cell stack unit 210 may be a pouch-type secondary battery, as illustrated in FIG. 4.

The battery cell 220, including a pouch-type secondary battery, may be configured in a form in which an electrode assembly (not illustrated) is accommodated in a pouch 221. The electrode assembly (not illustrated) may include a plurality of electrode plates and electrode tabs and may be accommodated in the pouch 221. The electrode plate may include an anode plate and a cathode plate, and the electrode assembly (not illustrated) may be configured in a form in which an anode and a cathode are stacked with a separator disposed therebetween while wide surfaces of the anode plate and the cathode plate face each other. The anode plate and the cathode plate may be formed to have a structure in which active material slurries are applied to a current collector. In general, the slurry may be prepared by stirring a particulate active material, an auxiliary conductive material, a binder, and a plasticizer with addition of a solvent. In the electrode assembly, a plurality of anode plates and a plurality of cathode plates may be stacked in a horizontal direction. In this case, the plurality of anode plates and the plurality of cathode plates may be provided with electrode tabs 225, respectively. The electrode tabs 225 may be connected to each other such that the same polarities thereof are in contact with each other.

In the case of the battery cell 220 illustrated in FIG. 4, the two electrode tabs 225 are illustrated as facing in opposing directions. However, the two electrode tab 225 may be disposed in the same direction while having different heights.

In addition, the pouch 221 is formed in the form of a container to provide an internal space in which the electrode assembly and an electrolyte (not illustrated) are accommodated. In this case, a portion of the electrode tab 225 of the electrode assembly may be exposed to an outside of the pouch 221.

The pouch 221 may be divided into an accommodation portion 222 and a sealing portion 223. The accommodation portion 222 may be formed in the form of a container to provide an internal space having a rectangular shape. The electrode assembly and the electrolyte maybe accommodated in the internal space of the accommodation portion 222.

The sealing portion 223 may be a portion to which a portion of the pouch 221 is bonded to seal a circumference of the accommodation portion 222. Therefore, the sealing portion 223 may be formed in the form of a flange extending outwardly of the accommodation portion 222 formed to have a container shape, and may be disposed along an external edge of the accommodation portion 222. Bonding of the pouch 221 for forming the sealing portion 223 maybe performed by thermal fusing, but example embodiments are not limited thereto.

In the present embodiment, the sealing portion 223 may be divided into a first sealing portion 223a, in which the electrode tab 225 is disposed, and a second sealing portion 223b in which the electrode tab 225 is not disposed.

In the present embodiment, the pouch 221 may be formed by forming a single sheet of exterior material. More specifically, the pouch 221 may be completed by forming one or two accommodation portions in the single sheet of exterior material, and then folding the exterior material such that the accommodation portions form a single space (for example, the accommodation portion 222).

In the present embodiment, the accommodation portion 222 may be formed in a rectangular shape. The sealing portion 223, formed by bonding an exterior material thereto, may be provided on an external edge of the accommodation portion 222.

However, as described above, the sealing portion 223 does not need to be formed on a surface on which the exterior material is folded. Therefore, in the present embodiment, the sealing portion 223 may be formed on the external edge of the accommodation portion 222 to be provided only on three surfaces of the accommodation portion 222, and may not be disposed on any one surface (a lower surface 226 of FIG. 4) of the external edge of the accommodation portion 222.

In the present embodiment, since the electrode tabs 225 are disposed to oppose each other, the two electrode tabs 225 maybe disposed on the sealing portions 223 formed on different sides. Accordingly, the sealing portion 223 of the present embodiment may include two first sealing portions 223a, in which the electrode tabs 225 are disposed, and one second sealing portion 223b in which the electrode tabs 225 are not disposed. In FIG. 4, the second sealing portion 223b is illustrated as being formed on an upper surface of the pouch 221, but the second sealing portion 223b may be formed on a lower surface of the pouch 221.

The pouch 221, used in an example embodiment of the present disclosure, is not limited to a structure in which a sealing portion 223 is formed on three surfaces by folding a sheet of exterior material, as illustrated in FIG. 4. For example, the accommodation portion 222 may be formed by overlapping two sheets of exterior material and the sealing portion 223 maybe formed on all four sides of the circumference of the accommodation portion 222. In this case, the sealing portion 223 may include two first sealing portions 223a, in which the electrode tabs 225 are disposed, and two second sealing portions 223b in which the electrode tabs 225 are not disposed. In this case, the second sealing portion 223b may be formed on an upper surface and a lower surface of the battery cell 220.

In addition, in the battery cell 220 of the present embodiment, the sealing portion 223 maybe folded at least once to increase bonding reliability of the sealing portion 223 and to significantly reduce an area of the sealing portion 223.

More specifically, the second sealing portion 223b, in which the electrode tab 225 is not disposed, of the sealing portion 223 according to the present embodiment may be folded twice and then fixed by an adhesive member 224. For example, the second sealing portion 223b may be folded by 180 degrees along a first bending line C1 illustrated in FIG. 4, and then folded once more along a second bending line C2 illustrated in FIG. 4. In this case, an adhesive member 224 may fill an inside of the second sealing portion 223b, and the second sealing portion 223b may be maintained in a twice-folded shape by the adhesive member 224. The adhesive member 224 may be formed of an adhesive having high thermal conductivity. For example, the adhesive member 224 may be formed of epoxy or silicone, but example embodiments are not limited thereto.

The above-configured battery cell 220 may be a nickel metal hydride (Ni-MH) battery or a lithium ion (Li-ion) battery which can be charged and discharged.

The battery cells 220 may vertically stand upright, and are then stacked in a horizontal direction to constitute the cell stack unit 210.

The electrode tabs 225, respectively provided in the plurality of battery cells 220, may be disposed such that the same polarities thereof are electrically connected to each other. To this end, the cell stack unit 210 may include a bus bar assembly (230 in FIG. 3) in which the electrode tabs 225, respectively provided in the plurality of battery cells 220, are disposed such that the same polarities thereof are electrically connected to each other. The bus bar assembly 230, provided in each of the cell stack units 210, maybe electrically connected to an electric component (160 of FIG. 3) such as a battery management system (BMS).

In the above, a description has been provided as to an example in which a pouch-type secondary battery is used as the battery cell 220. However, the battery cell provided in the cell stack unit 210 in the battery pack 100 according to an example embodiment is not limited to the pouch-type secondary battery, and may be configured as a can-type secondary battery. In this case, the can-type secondary battery may have a rectangular cross-section such that can-type secondary batteries maybe stacked to constitute the cell stack unit 210. In addition, when the battery cell 220 is configured as a can-type secondary battery, an electrode tab may be disposed on an upper surface of the battery cell 220, and each electrode tab may be connected to the bus bar assembly.

The partition wall member 250 may be disposed between adjacent cell stack units 210 to support a side surface of the cell stack unit 210 (for example, a side surface of the battery cell exposed outwardly). In addition, the partition wall member 250 maybe provided on opposite side surfaces of the cell stack unit 210. For example, as illustrated in FIG. 3, when six cell stack units 210 constitute a single row, the partition wall member 250 may be disposed between a side surface of an outermost cell stack unit 210 and an adjacent the cell stack unit 210 to include seven cell stack units 210.

The pack housing 110 may be configured to accommodate a plurality of cell stack units 210 and a plurality of partition wall members 250.

As illustrated in FIG. 3, such a pack housing 110 may include a bottom portion 111 having a bottom surface 112 and an external sidewall 113 extending upwardly of a circumference of the bottom portion 111. Accordingly, the pack housing 110 may be provided with an accommodation space 115 formed to be surrounded by the bottom portion 111 and the external sidewall 113. The cell stack unit 210 and the partition wall member 250 may be accommodated in the accommodation space 115. Although not illustrated in FIG. 3, the pack housing 110 may include cover member coupled to an upper portion of the external sidewall 113 to close the accommodation space 115.

As illustrated in FIG. 3 and FIGS. 5 to 8, the cell stack unit 210 and the partition wall member 250 may be accommodated in the pack housing 110 while a side surface of the cell stack unit 210 and a side surface of the partition wall member 250 are in contact with each other, and the partition wall member 250 may be fixed to the bottom surface 112 of the pack housing 110. In this case, the side surface of the cell stack unit 210 and the side surface 251a of the partition wall member 250 may be fixed by a double-sided tape.

Referring to FIG. 3 and FIGS. 5 to 8, the pack housing 110 may include a projection 130 having a structure protruding upwardly of the bottom surface 112. The projection 130 may be integrated with the bottom surface 112 of the pack housing 110, and maybe attached to the bottom surface 112 of the pack housing 110 after being prepared as a separated component.

As illustrated in FIG. 5, the partition wall member 250 may include a coupling portion 255 disposed therebelow to be coupled to the projection 130. For example, the partition wall member 250 may be fixedly installed on the bottom surface 112 of the pack housing 110 through the projection 130. In this case, as illustrated in FIG. 5, the coupling portion 255 may have a concave groove structure to accommodate the projection 130, and the projection 130 may have a convex protruding structure to be accommodated in the coupling portion 255. However, a method of coupling the coupling portion 255 and the projection 130 to each other is not limited thereto. For example, a groove concave may be formed in the projection 130 and a protruding structure may be formed on the coupling portion 255, so that the partition wall member 250 may have a structure in which the protruding structure of the coupling portion 255 is insertion-coupled to a groove shape of the projection 130.

Referring to FIG. 6, a fastening member “B” formed of a bolt, or the like, may be used to fasten the partition wall member 250 and the projection 130 to each other. Such a fastening member “B” may have a structure screw-coupled to a screw threshold formed on the projection 130 through the partition wall member 250. However, various known methods may be used to fasten the partition wall member 250 and the projection 130 to each other. As illustrated in FIGS. 7 and 8, a plurality of fastening holes 254 may be formed in the partition wall member 250 to fasten the fastening member “B,” and a plurality of fastening holes 131 may also be formed in the projection 130 to correspond to the plurality of fastening holes 254.

The projection 130 may have a linearly protruding shape in a length direction X1 of the partition wall member 250 as illustrated in FIG. 7. However, the projection 130 may have a partially protruding shape in a length direction X1 of the partition wall member 250, as illustrated in FIG. 8.

All of the partition wall members 250 may have the same width (a horizontal direction X2 of FIG. 5), but the partition wall member 250 disposed in a center of the pack housing 110 may have a width greater than a width of the partition wall member 250, disposed in an external side of the pack housing 110, to play a structural role and to sufficiently absorb swelling at the same time. In this case, the projection 130 may have a width corresponding to the width of the partitioning member 250 to be coupled to the coupling portion 255 of the partition wall member 250.

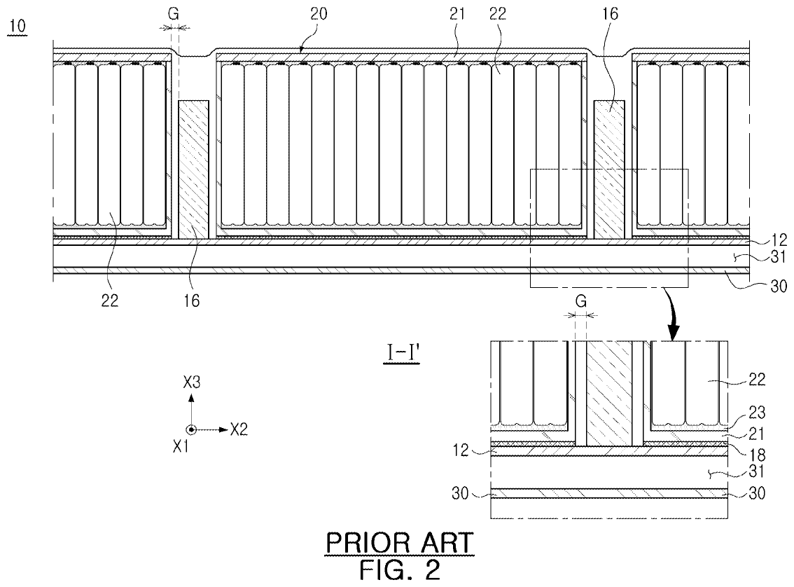

Referring to FIGS. 5 and 6, the cell stack unit 210 and the partition wall member 250 may be accommodated in the pack housing 110 while a side surface of a cell stack unit 210 and a side surface of the partition wall member 250 are in contact with each other. Accordingly, unlike the related art illustrated in FIG. 2, the battery pack 100 according to an example embodiment does not have a gap between a side surface of the cell stack unit 210 and a side surface 251a of the partition wall member 250. Therefore, in the battery pack 100 according to an example embodiment, more battery cell 220 may be installed in the same accommodation space 115, as compared with the related art. Thus, energy density of the battery pack 100 may be increased.

Moreover, in the battery pack 100 according to an example embodiment, the partition wall member 250 may be fixed to the bottom surface 112 of the pack housing 110 while the side surface of the cell stack unit 210 and the side surface 251a of the partition wall member 250 are in contact with each other. Therefore, the cell stack unit 210 having a heavy weight may be firmly confined and supported inside the pack housing 110 to sufficiently resist to external impact or external force.

Referring to FIG. 3, a plurality of cell stack units 210 and a plurality of partition wall members 250 may constitute a unit assembly 200. The unit assembly 200 may be assembled to be integrated with the pack housing 110. For example, FIG. 3 illustrates a structure in which a total of 12 cell stack units 210 are mounted in the battery pack 100, and six cell stack units 210 arranged in a row and seven partition wall members 250 coupled thereto may be formed as a single unit assembly 200. In this case, the unit assembly 200 including the six cell stack unit 210 may be assembled twice in the pack housing 110 in a row-by-row manner to complete assembly of the cell stack unit 210. However, the number of cell stack units 210, constituting the unit assembly 200, is not limited thereto. For example, among the six cell stack units 210 forming a row in FIG. 3, three cell stack unit 210 may constitute a single unit assembly 200.

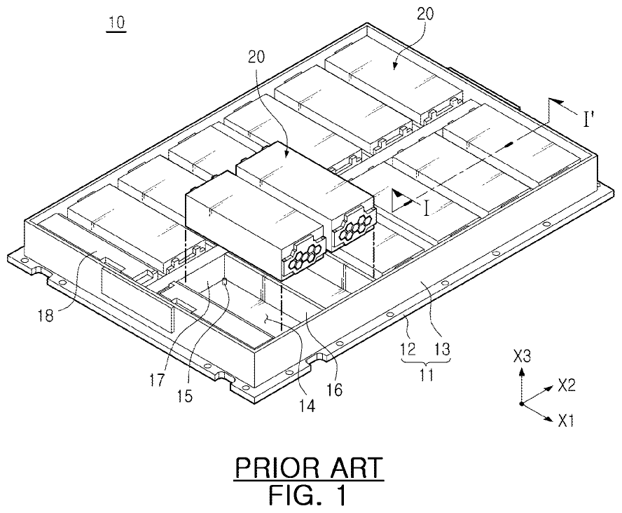

As described above, in the battery pack 100 according to an example embodiment, a plurality of cell stack units 210 may constitute the unit assembly 200 to be accommodated in the accommodation space 115 of the battery pack 100 at one time. Therefore, assemblability may be improved, as compared with the related art of FIG. 1 in which a plurality of battery modules 20 are installed in the accommodation spaces 14 of the battery pack 10, respectively.

The projection 130, formed to protrude from the bottom surface 112 of the pack housing 110, may have a height equal to half a height of the partition wall member 250 or less. That is, the projection 130 may be formed to have a relatively small height, as compared with a height of the partition wall member 250, to significantly reduce interference between the unit assembly 200 and the projection 130 when the plurality of cell stack units 210 and the plurality of partition wall members 250 constituting the unit assembly 200 are coupled to the pack housing 110. In addition, the partition wall member 250 may have a height corresponding to a height of the battery cell 220 to sufficiently support a side surface of the battery cell 220.

The partition wall member 250 may include a hollow portion 252, formed as an empty space inside the external wall 251, and a partition wall 253 partitioning the hollow portion 252. The battery cell 220 may expand due to a swelling phenomenon, and the hollow portion 252 of the partition wall member 250 may allow the partition wall member 250 to be compressed and deformed depending on the expansion of the battery cell 220 caused by the swelling phenomenon. Accordingly, the partition wall member 250 may be compressed and deformed to sufficiently absorb the swelling of the battery cell 220. A thickness of the partition wall 253, crossing the hollow portion 252, may be smaller than a thickness of the external wall 251 of the partition wall member 250 to facilitate the compression and deformation of the hollow portion 252.

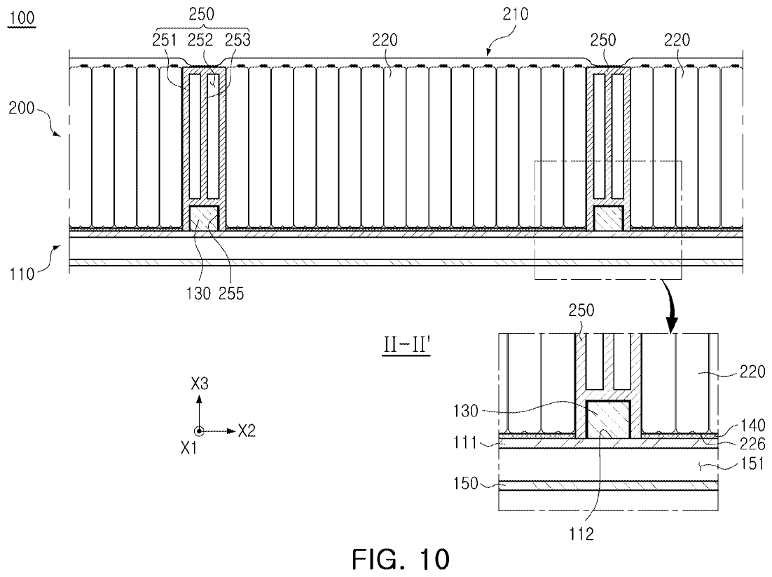

The partition wall 253 may have a shape crossing the hollow portion 252 of the partition wall member 250 in a horizontal direction X2, as illustrated in FIGS. 5 and 6, but example embodiments are not limited thereto. As illustrated in FIG. 10, the partition wall 253 may have a shape crossing the hollow portion 252 of the partition wall member 250 in a vertical direction X3.

Since the expansion of the battery cell 220 caused by the swelling phenomenon is greatest in a central region of the battery cell 220 (a portion corresponding to a middle height of the battery cell 220 of FIG. 5 in a vertical direction X3), the hollow portion 252 maybe formed in a position corresponding to the central region of the battery cell 220. In addition, the projection 130 may be disposed at a smaller height than the central region of the battery cell 220 so as not to interfere with the compression and deformation of the partition wall member 250 caused by the expansion of the battery cell 220.

The partition wall member 250 may be formed of a metal material, such as aluminum, to sufficiently support the side surface of the battery cell 220, for example, the side surface of the cell stack unit 210. However, the material of the partition wall member 250 is not limited thereto, and the partition wall member 250 may be formed of a synthetic resin material as long as rigidity may be secured. In addition, the partition wall member 250 may be formed through extrusion processing for ease of manufacturing. To this end, the partition wall member 250 may have a constant cross-sectional structure.

The battery pack 100 according to an example embodiment may be provided with various electric components (160 of FIG. 3) such as a battery management system (BMS). A cross member (120 of FIG. 3, a structure crossing the pack housing 110, may be installed in the battery pack 100.

A cooling member 150 may be installed in the pack housing 110 to dissipate heat generated by the battery cell 220.

The cooling member 150 may be installed below the bottom portion 111 of the pack housing 110. A cooling flow path 151, through which a cooling fluid such as water or air flows, may be formed in the cooling member 150. To form the cooling flow path 151, the cooling member 150 may be provided as a plate-shaped member forming the cooling flow path 151 between the cooling member 150 and the bottom portion 111 of the pack housing 110, as illustrated in FIGS. 5 and 6. However, the installation position and shape of the cooling member 150 is not limited thereto as long as the cooling flow path 151 may be formed. For example, the cooling member 150 may be formed as a separate structure, in which the cooling flow path 151 is formed, to be assembled below the bottom surface 112 of the pack housing 110 in which the cell stack unit 210 is installed.

A heat transfer member 140 may be installed between a lower surface of the cell stack unit 210 and the bottom surface 112 of the pack housing 110 to effectively transfer heat, generated by the battery cell 220, to the cooing member 150. For example, an upper side of the heat transfer member 140 may be configured to be in contact with the battery cell 220, and a lower side thereof may be configured to be in contact with the bottom surface 112 of the pack housing 110.

Accordingly, the heat generated by the battery cell 220 may be transferred to the cooling member 150 via the heat transfer member 140 and the bottom surface 112 of the pack housing 110 through the lower surface 226 of the battery cell 220. As a result, heat dissipation of the battery cell 220 may be effectively performed.

The heat transfer member 140 may be configured to include at least some of thermal grease, thermal adhesive, thermally conductive epoxy, and a heat dissipation pad to facilitate heat transfer, but example embodiments are not limited thereto.

Since the heat transfer member 140 serves to fix the lower surface of the cell stack unit 210 to the bottom surface 112 of the pack housing 110, the heat transfer member 140 may be configured to have adhesive strength of a certain level or higher.

As illustrated in FIG. 2, as compared with the battery pack 10 according to the related art having a heat transfer path passing through the lower surface of the module housing 21, the battery pack 100 according to an example embodiment may be configured such that the lower surface of the battery cell 220 and the bottom surface 112 of the pack housing 110 are in direct contact with each other to significantly shorten a heat transfer path between the battery cell 220 and the cooling member 150. Accordingly, the battery pack 100 according to an example embodiment may improve heat dissipation performance of the battery cells 220 and to significantly improve overall cooling performance of the battery pack 100.

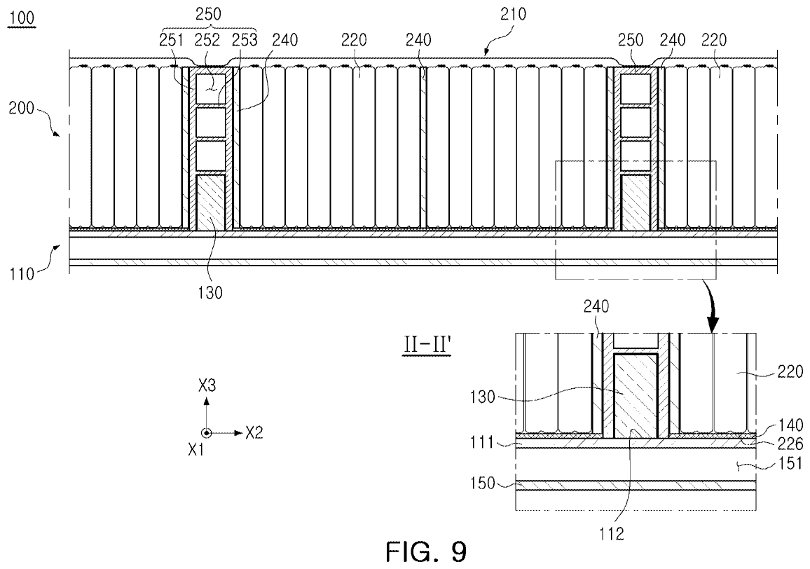

Hereinafter, a battery pack 100 according to another example embodiment of the present disclosure will be described with reference to FIG. 9. FIG. 9 is a cross-sectional view illustrating a modified example of the battery pack 100 illustrated in FIG. 5.

The embodiment of the battery pack 100 illustrated in FIG. 9 is different from the battery pack 100 illustrated in FIG. 5 only in that a cell stack unit 210 is additionally provided with a buffer pad 240. Therefore, detailed descriptions of the same or corresponding configurations as in the embodiment of the battery pack 100 described with reference to FIGS. 3 to 7 will be replaced with the above-described contents, and only the buffer pad 240 will be intensively described.

In the embodiment of FIG. 9, at least one buffer pad 240 may be provided between battery cells 220 constituting a cell stack unit 210. The buffer pad 240 may be configured to be in contact with a side surface (227 of FIG. 4) of an adjacent battery cell 220. Since the buffer pad 240 may be elastically deformed to be compressed when a specific battery cell 220 expands due to a swelling phenomenon, total volume expansion of the cell stack unit 210 including a plurality of battery cells 220 may be suppressed. To this end, the buffer pad 240 may be formed of a polyurethane material, but example embodiments are not limited thereto.

FIG. 9 illustrates an exemplary structure in which a total of three buffer pads 240 are disposed on opposite side surfaces and in the center of a single cell stack unit 210, but the number or installation position of buffer pads 240 provided in the cell stack unit 210 is not limited to that illustrated in FIG. 9.

In the battery pack 100 according to an example embodiment, a hollow portion 252 may be formed in a partition wall member 250, as described above. When a swelling phenomenon occurs, an external wall 251 of the partition wall member 250 may be compressed and deformed through the hollow portion 252 to absorb the swelling of the battery cell 220. Accordingly, when the hollow portion 252 is formed in the partition wall member 250 and the buffer pad 240 is additionally installed, the battery pack 100 may more effective cope with the swelling of the battery cell 220.

Hereinafter, a battery pack 100 according to another example embodiment of the present invention will be described with reference to FIG. 10. FIG. 10 is a cross-sectional view illustrating another modified example of the battery pack 100 illustrated in FIG. 5.

The embodiment of the battery pack 100 illustrated in FIG. 10 is different from the battery pack 100 illustrated in FIG. 5 only in a structure and a shape of a partition wall member 250 and a size of a projection 130. Therefore, detailed descriptions of the same or corresponding configurations as in the embodiment of the battery pack 100 described with reference to FIGS. 3 to 7 will be replaced with the above-described contents, and only the partition wall member 250 and the projection 130 will be intensively described.

The partition wall member 250 illustrated in FIG. 10 may include a hollow portion 252 having a hollow structure provided inside an external wall 251, and a partition wall 253 may be formed in the hollow portion 252 in a vertical direction X3. Accordingly, the partition wall member 250 of FIG. 10 may have a shape in which the hollow portion 252 extends in a vertical direction X3.

When the battery cell 220 is swollen, a side surface (227 of FIG. 4) of the battery cell 220 expands in a horizontal direction X2 of FIG. 10. Therefore, as illustrated in FIG. 10, when the hollow portion 252 of the partition wall member 250 is formed in a vertical direction X3, the external wall 251 of the partition wall member 250 may be easily deformed in the horizontal direction X2 to effectively cope with the expansion of the battery cell 220 caused by the swelling.

In addition, when the battery cell 220 is swollen, the degree of expansion of the battery cell 220 is generally greatest in a central portion of the battery cell 220 in a height direction. Accordingly, the hollow portion 252 of the battery cell 220 may be configured to have a shape extending in a vertical direction X3 in a position corresponding to the central portion of the battery cell 220 in the height direction, as illustrated in FIG. 10.

To this end, a projection 130 of a pack housing 110 and a coupling portion 255 of the partition wall member 250 coupled thereto maybe configured to have a smaller height than a height of the central portion of the battery cell 220 in the height direction. In addition, the projection 130 may have a height equal to ½ or less of the height of the partition wall member 250.

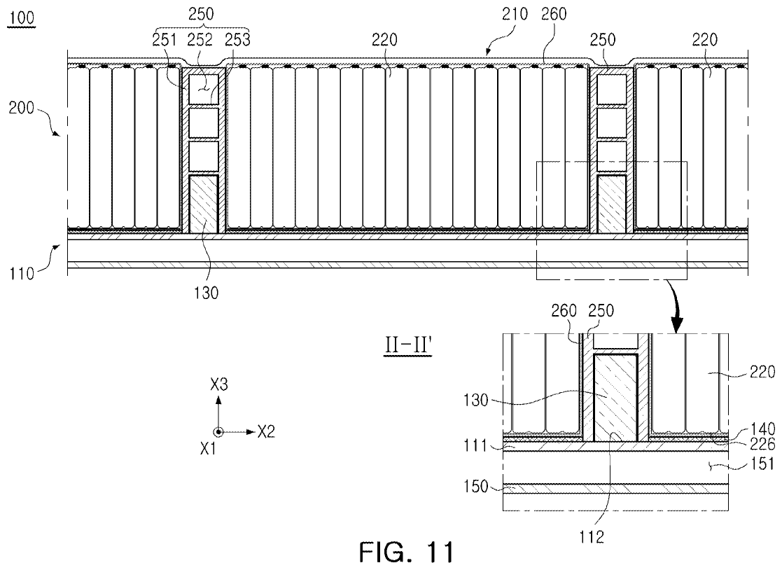

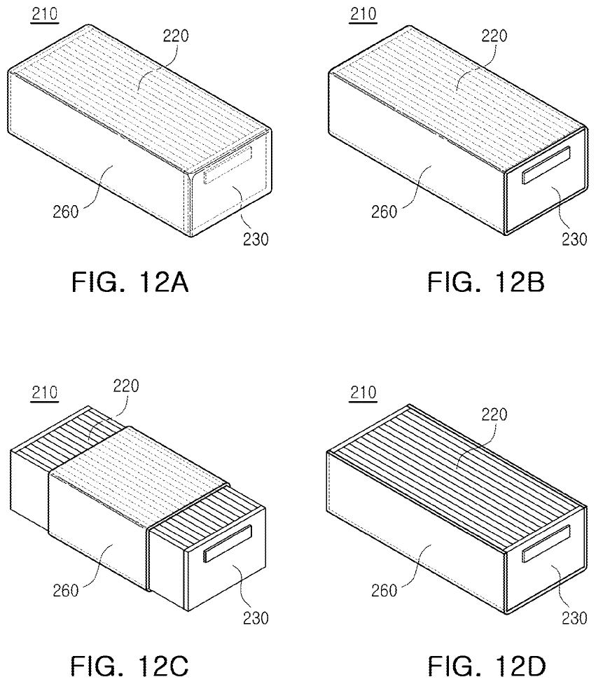

Hereinafter, a battery pack 100 according to another example embodiment of the present disclosure will be described with reference to FIGS. 11 and 12.

FIG. 11 is a cross-sectional view illustrating another modified example of the battery pack 100 illustrated in FIG. 5, and FIGS. 12A to 12D are perspective views illustrating various modified examples of the casing 260 included in the battery pack 100 illustrated in FIG. 11.

The embodiment of the battery pack 100 illustrated in FIG. 11 is different from the battery pack 100 illustrated in FIG. 5 only in that a cell stack unit 210 is additionally provided with a casing 260 wrapping at least a portion of a battery cell 220. Therefore, detailed descriptions of the same or corresponding configurations as in the embodiment of the battery pack 100 described with reference to FIGS. 3 to 7 will be replaced with the above-described contents, and only configuration of the casing 260 will be intensively described.

Referring to FIG. 11 and FIGS. 12A to 12D, the cell stack unit 210 may further include a casing 260, and the casing 260 maybe configured to cover at least a portion of a plurality of battery cells 220 in the state in which the plurality of battery cells 220 are stacked.

In particular, when the battery cell 220 is formed of a pouch-type secondary battery, a lower surface 226 of the battery cell 220 may be adjacent to and in contact with a cooling surface through a heat transfer member 140 to cause damage to the lower surface 226 of the battery cell 220. In this regard, the battery pack 100 according to an example embodiment may include a casing 260 wrapping at least a portion of an external surface of the battery cells 220 establishing a stacked state to protect the battery cells 220.

The casing 260 may have a small thickness to significantly reduce an influence on a cooling path for heat transfer of the battery cell 220 while serving to protect a surface (a lower surface 226) of the battery cell 220.

To this end, the casing 260 may have a thickness of 0.5 mm or less, in detail, may include a thin film having a thickness of 0.1 mm or less, and may have a thickness of 0.03 mm. In addition, the casing 260 may be formed of a thermally conductive plastic material to smoothly transfer heat. However, a material of the casing 260 is not limited thereto as long as it may perform heat transfer and surface protection of the battery cell 220.

The casing 260 may have a shape to protect the surface of the battery cell 220, in detail, the lower surface 226 adjacent to the cooling member 150. The shape of the casing 260 may vary as long as it may wrap at least a portion of the lower surface of the battery cell 220.

For example, the casing 260 may have a shape wrapping all six sides of the cell stack unit 210 as illustrated in FIG. 12A, may have a shape wrapping four sides (upper, lower, left, and right sides) of the stack unit 210 as illustrated in FIG. 12B, and may have a shape wrapping portions of four sides (upper, lower, left, and right sides) of the stack unit 210 in the form of a band as illustrated in FIG. 12C.

In addition, the casing 260 may have a shape wrapping three surfaces (left, right, and lower surfaces) of the cell stack unit 210 as illustrated in FIG. 12D.

As described above, when the cell stack unit 210 includes the casing 260, a heat transfer member 140 may be disposed between a lower surface of the casing 260 and a bottom surface 112 of a pack housing 110. Accordingly, heat generated by the battery cell 220 may be transferred to a cooling member 150 through the casing 260 having a small thickness having thermal conductivity, the heat transfer member 140, and the bottom surface 112 of the pack housing 110 to dissipate the heat of the battery cell 220.

As described above, since the casing 260 provided in the battery pack 100 according to an example embodiment has a significantly small thickness and sufficient heat conduction performance as compared with a module housing according to the related art having a large thickness, the battery pack 100 according to an example embodiment may implement simplicity of a thermal transfer path to significantly improve heat dissipation performance and cooling performance.

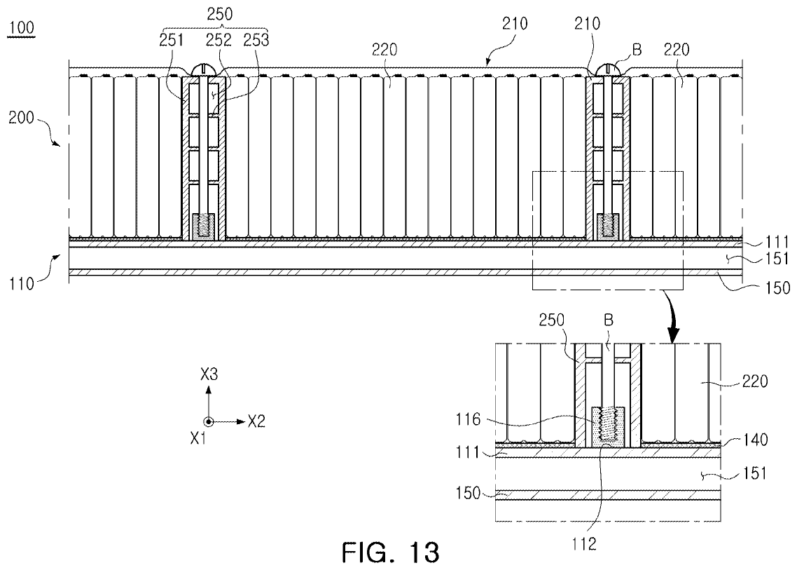

Hereinafter, a battery pack 100 according to another example embodiment of the present invention will be described with reference to FIG. 13.

FIG. 13 is a cross-sectional view illustrating another modified example of the battery pack 100 illustrated in FIG. 5.

The embodiment of the battery pack 100 illustrated in FIG. 13 is different from the battery pack 100 illustrated in FIG. 5 only in that a partition wall member 250 is directly and fixedly installed on a bottom surface of a pack housing 110. Therefore, detailed descriptions of the same or corresponding configurations as in the embodiment of the battery pack 100 described with reference to FIGS. 3 to 7 will be replaced with the above-described contents, and only a coupling structure of the partition wall member 250 and the bottom surface 112 will be intensively described.

In the embodiment illustrated in FIG. 13, the partition wall member 250 may be directly installed on the bottom surface 112 of the pack housing 110 to be fixed thereto. In this case, the partition wall member 250 and the bottom surface 112 of the pack housing 110 maybe fastened by a fastening member “B” such as a bolt. However, when the partition wall member 250 is not formed to have a sufficient thickness for fastening of the fastening member “B” on the bottom surface 112 of the pack housing 110, the fastening rib 116 may be formed on the bottom surface 112 of the pack housing 110 to partially protrude at a small height. In this case, the partition wall member 250 may be fastened to the fastening rib 116 through the fastening member B.

In this case, since the fastening rib 116 is used only to fasten the fastening member “B,” the fastening rib 116 may have a height smaller than a height of a coupling portion (255 of FIG. 5) of the partition wall member 250 and may have a width smaller than a width of the coupling part 255. However, the shape or structure of the fastening rib 116 is not limited thereto.

FIG. 13 illustrates an exemplary case in which a fastening member “B” such as a bolt is used in the coupling structure of the partition wall member 250 and the bottom surface 112, but the coupling between the partition wall member 250 and the bottom surface 112 may vary and may be achieved using, for example, adhesion such as bonding.

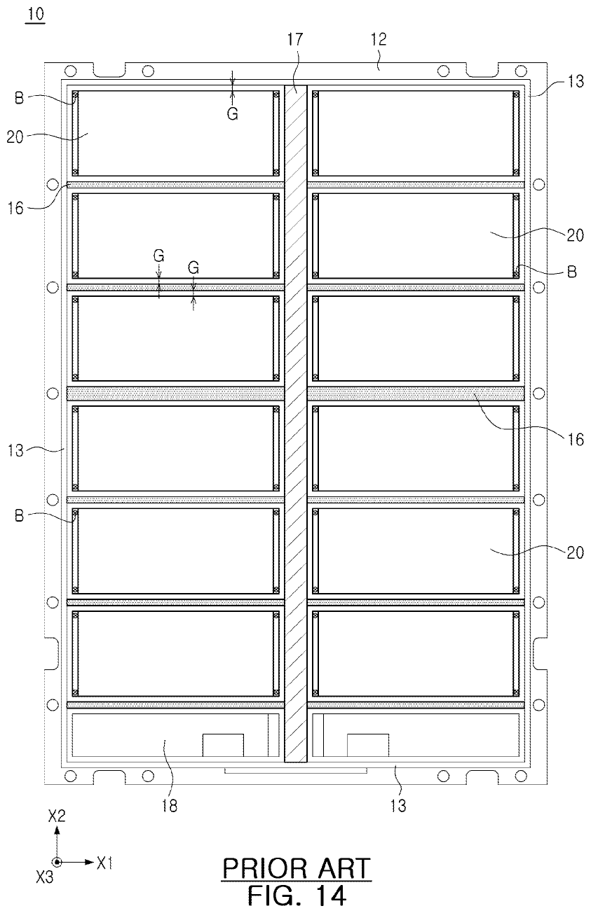

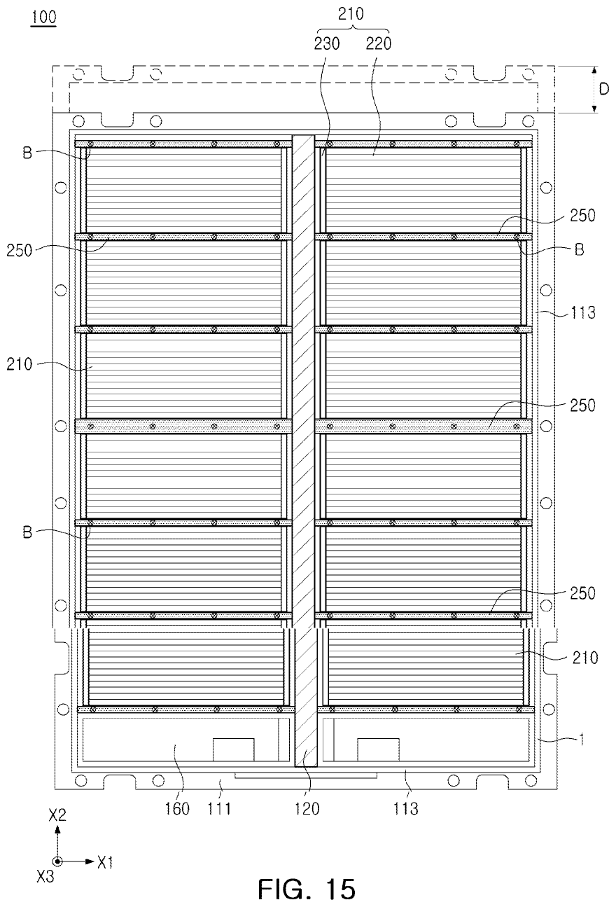

Hereinafter, the operation and effects of the battery pack 100 according to an example embodiment of the present disclosure will be described with reference to FIGS. 14 and 15.

FIG. 14 is a plan view of the battery pack 10 according to the related art illustrated in FIG. 1, and FIG. 15 is a plan view of the battery pack 100 according to an example embodiment of the present disclosure illustrated in FIG. 3. A dashed-line portion indicated in an upper portion of FIG. 15 represents a size of the battery pack 10 according to the related art illustrated in FIG. 14.

As illustrated in FIG. 14, in the battery pack 10 according to the related art, a gap G may be formed between the partition wall 16 and the battery module 20 and between the sidewall potion 13 and the battery module 20. Accordingly, in the battery pack 10 according to the related art, many empty spaces not used for mounting of the battery cell 22 due to the gap G (that is, many dead spaces) may be formed to prevent energy density from sufficiently increasing.

However, as illustrated in FIG. 15, in the battery pack 100 according to an example embodiment of the present disclosure, a gap is not formed between the cell stack unit 210 and the partition wall member 250, so that more battery cells 220 may be installed in a space having the same volume, as compared with the battery pack 10 according to the related art. Accordingly, the battery pack 100 according to an example embodiment of the present disclosure may sufficiently increase the energy density of the battery pack 100. In particular, the battery pack 100 according to an example embodiment of the present disclosure does not have a configuration corresponding to the module housing (21 in FIG. 1) provided in the battery pack 10 according to the related art, and thus, a space corresponding to a thickness of a module housing may also be used for mounting of the battery cells 220. Therefore, the energy density of the battery pack 100 may be sufficiently secured.

Comparing FIGS. 14 and 15 with each other, in the battery pack 100 according to an example embodiment of the present disclosure illustrated in FIG. 15, a length of the pack housing 110 may be decreased by “D,” as compared with the battery pack 10 according to the related art illustrated in FIG. 4. Thus, energy density may be significantly increased based on the same volume.

In the case of the battery pack 10 according to the related art, four corner portions of the battery module 20 may be installed on the bottom portion 12 by the fastening member “B.” Therefore, it may be difficult for the battery pack 10 according to the related art to sufficiently support the battery module 20 having a heavy weight.

Meanwhile, in the battery pack 100 according to an example embodiment of the present disclosure, the partition wall member 250 may be firmly fixed to the bottom surface 112 of the pack housing 110 through a plurality of fastening members “B” while the side surface of the cell stack unit 210 and the side surface of the partition wall member 250 are in contact with each other. In addition, the lower surface of the cell stack unit 210 may be fixed to the bottom surface 112 by the heat transfer member 140. Therefore, the battery pack 100 according to an example embodiment of the present disclosure may firmly constrain and support the cell stack unit 210 having a heavy weight inside the pack housing 110. As a result, the cell stack unit 210 may be prevented from departing or moving from a fastening position.

As illustrated in FIG. 15, the pack housing 110 may include a cross member 120 connecting opposing external walls 113 of the pack housing 110 to each other, and the partition wall member 250 may be installed such that both ends of the partition wall member 250 are in contact with at least one of the external wall 113 and the cross member 120.

In this case, the partition wall member 250 forms a grid-shaped skeleton inside the pack housing 110 together with the cross member 120 and the external wall 113. Accordingly, the battery pack 100 according to an example embodiment of the present disclosure may sufficiently secure structural rigidity of the pack housing 110, similarly to the partition wall 16 and cross member 17 of the related art illustrated in FIG. 1. In particular, both ends of the partition wall member 250 may be in contact with the cross member 120 and the external sidewall 113 while maintaining the state in which the side surface (251a of FIG. 7) is in contact with the side surface of the cell stack unit 210, so that the cell stack unit 210, a heavy-weight object, may be sufficiently supported.

As described above, according to an example embodiment having the above-described configuration, the cell stack unit and the partition wall member are accommodated in a pack housing while a side surface of a cell stack unit and a side surface of a partition wall member are in contact with each other. Accordingly, energy density of a battery pack may be increased.

In addition, as compared with a battery pack according to the related art, a heat transfer path between a battery cell and a cooling member may be significantly reduced to improve heat dissipation performance of the battery cell and to improve cooling performance of the battery pack.

In addition, a hollow portion may be installed in a partition wall member to sufficiently absorb swelling of any one of the plurality of a battery cells, and a buffer pad may be installed between battery cells to further reduce the swelling of the battery cell.

In addition, a partition wall member may be fixed to a bottom surface of a pack housing while a side surface of a cell stack unit and a side surface of a partition wall member are in contact with each other. Therefore, a cell stack unit having a heavy weight may be firmly constrained and supported inside a pack housing to sufficiently resist to an external impact or an external force.

In addition, a partition wall member having a state in contact with a cell stack unit may be fixedly installed in a pack housing to be integrated with the pack housing, so that structural rigidity of a battery pack may be sufficiently secured. In particular, when both ends of the partition wall member are installed to be in contact with at least one of an external sidewall of the pack housing and a cross member, the partition wall member may serve as a structure in the pack housing to further improve the structural rigidity.

In addition, a plurality of cell stack units and a plurality of partition wall members may be formed as a unit assembly, and the unit assembly may be assembled to be integrated with a pack housing. Thus, overall assemblability for forming a battery pack may be improved.

While example embodiments have been shown and described above, it will be apparent to those skilled in the art that modifications and variations could be made without departing from the scope of the present disclosure as defined by the appended claims.

What is claimed is:

1. A battery pack comprising:
a plurality of cell stack units, each cell stack unit including a stack of a plurality of battery cells;
a partition wall member disposed between the cell stack units adjacent to each other; and
a pack housing accommodating the plurality of cell stack units and a plurality of partition wall members,
wherein the cell stack unit and the partition wall member are accommodated in the pack housing while a side surface of the cell stack unit and a side surface of the partition wall member are in contact with each other, and
wherein the partition wall member is fixed to a bottom surface of the pack housing.

2. The battery pack of claim 1, wherein the pack housing includes a projection having a structure protruding upwardly of the bottom surface,
wherein the partition wall member includes a coupling portion coupled to the projection for fixing the partition wall member on the bottom surface of the pack housing.

3. The battery pack of claim 2, wherein the projection has a shape linearly protruding in a length direction of the partition wall member, or has a shape partially protruding in the length direction of the partition wall member.

4. The battery pack of claim 2, wherein the projection has a height equal to half a height of the partition wall member or less.

5. The battery pack of claim 1, wherein the partition wall member is directly and fixedly installed on a bottom surface of the pack housing.

6. The battery pack of claim 1, wherein at least a portion of the partition wall member includes a hollow portion having a hollow structure to absorb swelling of any one of the plurality of battery cells.

7. The battery pack of claim 6, wherein the hollow portion has a shape extending in a vertical direction.

8. The battery pack of claim 6, wherein the partition wall member includes an external wall defining the hollow portion and a partition wall crossing the hollow portion, and
wherein the partition wall has a thickness smaller than a thickness of the external wall of the partition wall member.

9. The battery pack of claim 1, wherein the plurality of cell stack units and a plurality of partition wall members constitute a unit assembly, and
wherein the unit assembly is assembled to be integrated with the pack housing.

10. The battery pack of claim 1, wherein the pack housing includes a bottom portion having the bottom surface, an external sidewall extending upwardly of a circumference of the bottom portion, and a cooling member installed below the bottom portion.

11. The battery pack of claim 10, further comprising a heat transfer member positioned between a lower surface of the battery cell and the bottom surface of the bottom portion of the pack housing, and
wherein heat generated by the battery cell is transferred to the cooling member through the heat transfer member and the bottom portion.

12. The battery pack of claim 10, wherein the cell stack unit includes a casing wrapping at least a portion of the plurality of battery cells in a state in which the plurality of battery cells are stacked.

13. The battery pack of claim 1, wherein the battery cell comprises a pouch-type secondary battery having an accommodation portion, accommodating an electrode assembly therein, and a sealing portion sealing the accommodation portion.

14. The battery pack of claim 1, wherein the battery cell comprises a can-type secondary battery.

15. The battery pack of claim 1, wherein the pack housing includes a cross member connecting opposing external sidewalls of the pack housing to each other, and
wherein the partition wall member is installed such that both ends of the partition wall member are in contact with at least one of the external sidewall and the cross member.

16. A battery pack comprising:
a pack housing;
a plurality of partition wall members being fixed to the pack housing and spaced apart at a regular interval from each other; and
a plurality of cell stack units, each of the plurality of the cell stack units being positioned between consecutive partition wall members;
wherein each cell stack unit includes a plurality of battery cells stacked adjacent to each other,
wherein opposite side surfaces of each of the cell stack units are in contact with a corresponding side of the two consecutive partition wall members between which the cell stack unit is positioned.

17. The battery pack of claim 16, wherein the pack housing includes a plurality of projections corresponding to the plurality of partition wall members for attaching the plurality of partition wall members to the pack housing.

18. The battery pack of claim 17, wherein the projections have a shape complimentary to a shape of a coupling of the corresponding partition wall members for coupling the projections to the corresponding partition wall members.

19. The battery pack of claim 16, wherein each partition wall member includes an external wall defining a hollow portion and a partition wall crossing the hollow portion and connecting opposite sides of the external wall, and
wherein the partition wall has a thickness smaller than a thickness of the external wall of the partition wall member.

20. The battery pack of claim 16, further comprising a heat transfer member positioned between a lower surface of the battery cells and the bottom surface of the bottom portion of the pack housing, and
wherein heat generated by the battery cells is transferred to a cooling member through the heat transfer member and the bottom portion.
